(19) United States
(12) Patent Application Publication
(10) Pub. No.: US 2021/0172916 A1
(43) Pub. Date: Jun. 10, 2021

(54) METHODS AND SYSTEMS FOR MONITORING PEROXYACID CONTENT IN A FLUID

(71) Applicant: CHEMTREAT, INC., Glen Allen, VA (US)

(72) Inventors: Kevin White, Glen Allen, VA (US); Benjamin Niemaseck, Glen Allen, VA (US); James Wilkins, Midlothian, VA (US); Mark J Puchovich, Henrico, VA (US)

(21) Appl. No.: 17/048,312

(22) PCT Filed: Apr. 15, 2019
(86) PCT No.: PCT/US19/27429

§ 371 Date: Oct. 16, 2020

Related U.S. Application Data
(60) Provisional application No. 62/660,000, filed on Apr. 19, 2018.

(51) Int. Cl. G01N 31/22; G01N 21/82

(52) U.S. Cl. CPC G01N 31/228; G01N 2021/755; G01N 21/82

(57) ABSTRACT

Methods and systems are described for quantifying peroxyacid in a fluid by using spectrophotometry. Peroxyacid in the fluid is reacted with an iodide reagent and the absorbance of the reaction solution is measured. The absorbance can be measured at or near the isosbectic wavelength of iodine and triiodide, and the assay is useful to quantify peroxyacid that is present at high levels in fluids.

### TECHNICAL FIELD

This disclosure is directed to methods and systems for detecting and quantifying peroxyacids in a fluid by using an iodide-containing reagent. The absorbance of the reacted fluid sample can be correlated to the amount of peroxyacid in the fluid, which in turn can be used to control the amount of peroxyacid added to the fluid.

### BACKGROUND

Peroxyacids, such as peracetic acid, are strong oxidizing agents that can be used as disinfectants in industrial systems, in particular as a sanitizer in food and beverage production plants. Peracetic acid is one peroxyacid that is used as an alternative to quaternary ammonium complexes to disinfect water streams because it is EPA-approved and has a less detrimental effect on microbes in downstream waste processing.

It can be challenging to measure amounts of peroxyacid in industrial fluid systems. Peroxyacids can be measured by collecting a sample and performing redox titration methods. Iodometry/iodimetry is one such class of titration method, where iodine can be used to quantify organic and inorganic substances, such as peracetic acid. Currently, peracetic acid is usually measured through a manual titration drop test kit with an accuracy of +/−15-30 ppm. These test kits are subject to degradation in the work environment and over time will provide inaccurate numbers. Additionally, quality control between test kits can be poor resulting in two of the same test kits providing dramatically different results.

Other techniques include using electrodes to measure the diffusion of peroxyacids across a membrane. However, the membrane caps are very sensitive and require a constant fluid flow, are prone to fouling, and are affected by temperature variations. In particular, these types of sensors are disrupted in circumstances where there is stagnant fluid or the fluid flow is shut off.

### SUMMARY

Current tests for peroxyacids, especially in an industrial setting, are time consuming, limited in their effectiveness due to testing conditions and largely inaccurate due to the designs of the test and user error. Aspects of this invention provide reliable techniques for quantifying peroxyacids in fluids, particularly fluids containing high levels of peroxyacids.

According to one aspect, this disclosure provides a method for determining an amount of peroxyacid in a fluid that includes steps of (i) combining an iodide-containing reagent with the fluid, and allowing peroxyacid in the fluid to react with the iodide from the reagent, (ii) then measuring an absorbance of the fluid at a wavelength that is in the range of from 459 nm to 469 nm, and (iii) determining the amount of peroxyacid in the fluid based on the measured absorbance.

According to another aspect, this disclosure provides a system for analyzing the peroxyacid content in water, where the system includes (i) a reagent vessel that contains an iodide-containing reagent, (ii) a fluid conduit or fluid container configured to receive the water and the iodide-containing reagent, and allow peroxyacid in the water to react with the iodide from the reagent to provide a reaction fluid, and (iii) a spectrophotometer that is configured to emit light at a wavelength that is in the range of from 461 nm to 467 nm, and measure an absorbance of the reaction fluid at the wavelength.

### BRIEF DESCRIPTION OF THE DRAWINGS

FIG. 1 is a graph illustrating absorbances of reaction samples in which 50 ppm of peracetic acid is reacted with varying concentrations of potassium iodide.

FIG. 2 is a schematic diagram illustrating one embodiment of an automated system for quantifying peroxyacid.

### DETAILED DESCRIPTION OF EMBODIMENTS

This disclosure relates to methods, systems, and apparatuses that can quantify peroxyacids in a fluid. Peroxyacids can include, for example, peracetic acid, performic acid, peroxymonosulfuric acid, peroxynitric acid, and meta-chloroperoxybenzoic acid.

Peroxyacids are useful in many applications for their oxidative properties, where they are typically combined with fluids such as water. The water can be a water stream, reservoir, or bath used in any system, and typically comprises at least 90 wt. % water, and more typically at least 95 wt. % water.

Peroxyacids can be used as a biocide or antimicrobial agent because they are useful in killing bacteria, yeasts, molds, and algae. This can be useful, for example, in food, beverage, and medical industries which have environments that foster microbe growth. Also, peracetic acid is approved for food contact by the FDA within certain concentrations, and can be applied directly to food surfaces to disinfect it.

In use, peroxyacids can be mixed with water and optionally other chemicals, and then items to be sterilized or disinfected are sprayed with the mixture or are immersed in the mixture. For example, in meat industries, animal carcasses can be sprayed with an aqueous solution of peracetic acid to reduce bacteria. The disinfected items can then be rinsed before use. The peroxyacid solution and/or water that is contacted with the items is collected in a wash water stream or reservoir and is typically recycled and reused in the disinfection process.

The oxidation properties of the peroxyacid disrupt cell membranes of the microbes. This oxidation kills the microbes and depletes the peroxyacid concentration in the water. Any rinse water that is added to the wash water will likewise diminish the concentration of peroxyacid in the water, as will natural decomposition of the peroxyacid over time. To ensure effective sterilization or disinfection, the concentration of the peroxyacid must be maintained above a minimum effective level. This minimum effective level may vary depending on the application, but it could be within the range of 1 ppm to 5,000 ppm, from 20 ppm to 500 ppm, from 100 ppm to 300 ppm, or from 150 ppm to 250 ppm. For example, in meat industries the minimum effective level of peroxyacid is typically about 200 ppm. In other application, such as medical instrument sterilization, the minimum effective level may be within the range of from 1000 ppm to 4,000 ppm, or from 2,000 ppm to 3,000 ppm.

It may also be desirable to establish a maximum peroxyacid level to maintain costs, to ensure that the solution is safe, and to prevent excessive corrosion of equipment and conduits that are used in the system. For example, the maximum peroxyacid level can be from 1.2 to 5 times higher than the minimum effective level, from 1.5 to 4 times higher than the minimum effective level, or from 2 to 3 times higher than the minimum effective level.

It is useful to quantify peroxyacids in fluids to control the concentration in the fluid to be at or above the minimum effective level and at or below the maximum level. According to aspects of this invention, the peroxyacid content in the fluid can be quantified by mixing a sample of the fluid with a reagent that includes iodide and then reacting the peroxyacid with the iodide. Without intending to be bound by theory, it is believed that the reaction proceeds as follows:

RCOOOH+2I⁻+2H⁺→I₂+RCOOH+H₂O (1)

As can be seen from reaction (1), the quantity of peroxyacid in the sample can be determined from the amount of iodine generated from the oxidation of the iodide. However, under some conditions iodine can be volatile and come out of solution. However, in the presence of excess iodide, I₂ will complex with the iodide to form triiodide according to the following reaction:

I⁻+I₂ [symbol] I₃⁻ (2)

The combination of iodine and triiodide is more stable in solution. Provided that the iodide reagent is added in at least sufficient amounts to react with all of the peroxyacid present, the amount of peroxyacid in solution is directly proportional to the net concentrations of iodine and triiodide and can be determined with spectrophotometry based on the light absorbances of those components. Triiodide has absorbance peaks around 280 nm and 352 nm, and iodine has a broad absorbance peak around 475 nm. However, the absorbances at these wavelengths can be too sensitive to the amount of peroxyacid, and may be unsuitable to quantify peroxyacid where it is present in amounts of greater than about 10 ppm because the absorbance peak is too intense.

In one aspect, it can be advantageous to quantify the peroxyacid by measuring the light absorbance of the reaction solution at or near the isosbectic point for iodine and triiodide. The isosbectic point is the wavelength at which the net absorbance of iodine and triiodide is proportional to the combined concentrations of those two components, and does not depend on the specific amount of either component. Quantifying the peroxyacid based on the absorbance at the isosbectic point can reduce aberrations due to fluctuating amounts of iodide reagent added to sample or due to flow rate fluctuations. Additionally, this technique can be used to quantify a peroxyacid that is present in the fluid at high levels, for example, where it is present in the fluid in amounts of 25 ppm or greater, 100 ppm or greater, or 200 ppm or greater, and up to 10,000 ppm.

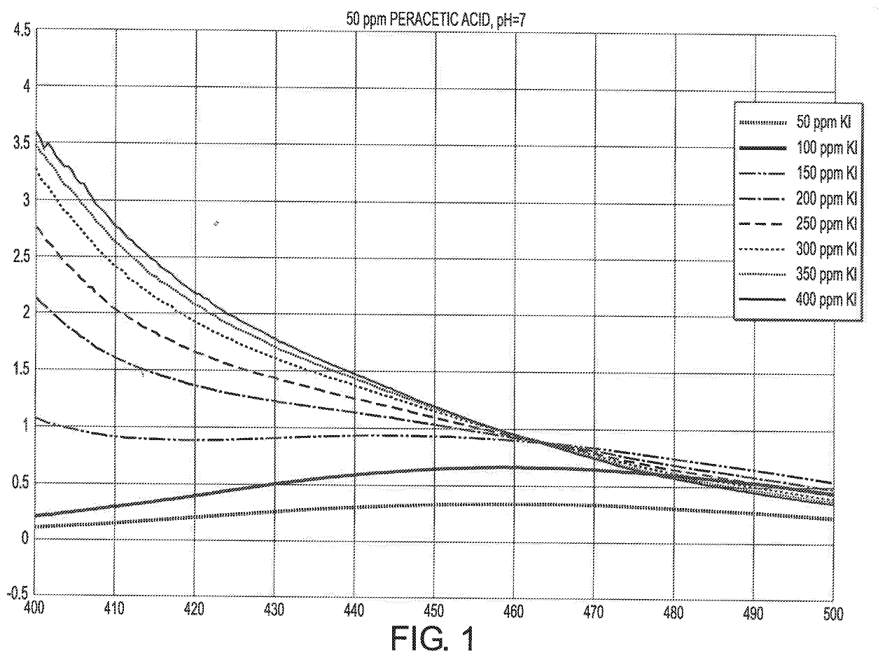

FIG. 1 shows the absorbance spectra (from 400 nm to 500 nm) of eight different samples in which 50 ppm of peracetic acid in water at pH 7 is reacted with varying concentrations of potassium iodide. As can be seen, provided that iodide reagent is added above a threshold amount, the absorbance of the reaction sample does not change at the isosbectic point even with varying amounts of iodide added. The iodide reagent can be added so that the iodide is present in a stoichiometric excess. Of course, since the amount of peroxyacid is unknown, the iodide is typically added significantly in excess of the expected range of peroxyacid, for example, at least twice as much as the expected value or at least 5 times as much as the expected value. In this regard, if the expected (or desired) range of peroxyacid is about 200 to 400 ppm, iodide reagent can be added so that the iodide content is greater than 1,000 ppm, e.g., in the range of 2,500 ppm to 5,000 ppm. Likewise, if the expected or desired range of peroxyacid is about 2,000 ppm to 3,000 ppm, the iodide reagent can be added so that the iodide content is greater than 6,000 ppm, e.g., in the range of 10,000 ppm to 20,000 ppm.

As can be seen in FIG. 1, the isosbectic point is about 463 nm to 464 nm, which corresponds to the iodine/triiodide isosbectic wavelength. The precise isosbectic wavelength may vary (e.g., by +/−2 nm) depending on the spectrophotometer used. The amount of peroxyacid present in the sample can therefore be quantified based on the reaction sample absorbance at this isosbectic wavelength, e.g., by comparing the absorbance to a standard calibration curve that is generated beforehand from samples having known quantities of peroxyacid. This technique provides for accurate and reproducible results, with an expected precision on the same sample of less than 3% deviation and preferably less 1% deviation.

It is also anticipated that the peroxyacid could be reliably quantified at wavelengths within about +/−5 nm from the isosbectic point, e.g., in the range of from 459 nm to 469 nm, from 461 nm to 467 nm, or from 462 nm to 466 nm. At wavelengths farther away from the isosbectic point, the absorbance of the reaction sample will shift constantly, making the measurement unreliable. This occurs because, if the flow or reagent feed change, the concentration of total I⁻ in solution will change. This, in turn, can affect the ratio of I₃⁻:I₂ and thus most wavelengths will contain large deviations, making them unsuitable for reliable quantification as demonstrated in FIG. 1.

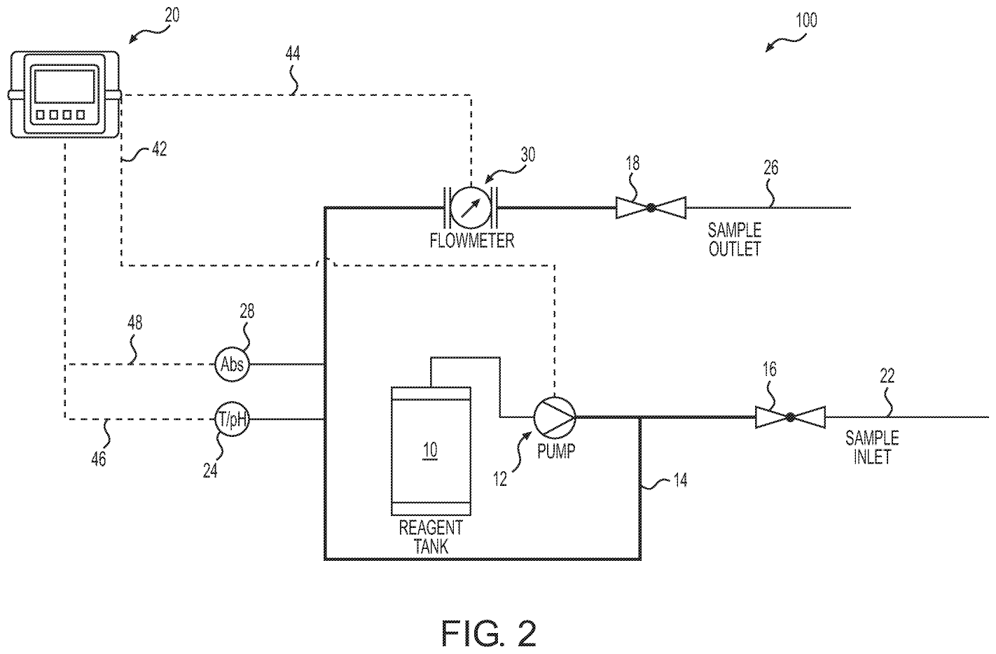

FIG. 2 is a schematic diagram illustrating an automated system 100 for analyzing the quantity of peracetic acid in wash water that is used, for example, as a disinfectant in the food industry. In food industries, the peracetic acid is added to the water before it is sprayed onto food, and then the wash water is recirculated for reuse. The sample can be taken from the recirculating water at a point before fresh peracetic acid is added to the water.

The system 100 includes a sample inlet 22 in which a sample of the water is drawn into the system by opening valve 16. The valve 16 can be open to flush the system before each measurement. And prior to adding reagent, a baseline measurement of absorbance of the water can be taken using spectrophotometer 28 when the water flows past and through the spectrophotometer. In this example, the spectrophotometer emits light at about 465 nm and measures the sample absorbance.

A sample of the water can then be taken into the system. The sample intake can be controlled through the use of the valve or a pump so that it flows at a constant flow rate. The sample can be any size, but in this example, is typically about 1 to 4 gallons. The pump 12 pumps potassium iodide from reagent tank 10 and combines it with the water sample so that the peracetic acid in the water sample reacts with the iodide immediately and causes a change in the absorbance measured by the spectrophotometer 28. Controller 20 can send a signal to the pump over a wired or wireless communication line 42 to control the operation of the pump.

In this example, the reagent is an aqueous solution of approximately 50 wt. % potassium iodide, and sufficient potassium iodide is pumped so that it is added to the sample in amounts of about 5,000 ppm. Other iodide-containing sources may be used as the reagent, for example, other metal iodides, and the reagent solution may be formulated in any amount.

The absorbance of the reaction sample at 465 nm is measured with spectrophotometer 28 and the absorbance is communicated to the controller 20 over wired/wireless communication line 48.

Optionally, other sensors can be placed on conduit 14, such as a turbidity sensor or a pH sensor 24 as shown. In this regard, the pH of the reaction solution should be maintained at 7 or lower, and if there is a potential for the pH to be higher than 7, it can be monitored and controlled. Also, since excessive turbidity can affect the absorbance of the sample, it may be useful to know when the sample exceeds a threshold turbidity level. The information from sensors 24 can be communicated to controller 20 along wired/wireless communication line 46.

The flowmeter 30 can take measurements of the flow rate of the sample fluid and communicate the measurements to controller 20 along wired/wireless communication path 44. The controller can use this information to control the flow of the sample to be within a certain range, e.g., 0.5 to 5 gallons per minute, and to maintain a substantially constant flow rate.

The sample then exits the system 100 through valve 18 and sample outlet 26, and is typically discarded.

The controller 20 may be a processor or CPU. The controller can be coupled to a memory and display, e.g., as in a laptop, desktop, or tablet computer. The controller 20 can control pump additions of pump 12, sample intake, flush intake, and can record readings of sensors 24, spectrophotometer 28, and flowmeter 30. The controller 20 can control the display to display these readings and calculate the peracetic acid concentration. The readings and calculations can be stored in the memory.

The controller 20 can calculate the peracetic acid content in the sample by (i) subtracting the baseline measurement from the sample measurement, and (ii) comparing the value to a previously prepared standard calibration curve that is stored in the memory. Taking a reading of the sample before the reagent is added (“baseline measurement”) improves the reliability of the measurement since effects on the absorbance relating to water turbidity can be cancelled.

Based on the calculated amount of peracetic acid in the wash water, the quantity of peracetic acid (or other peroxyacid) in the water can be precisely controlled manually or automatically. For example, if the amount of peracetic acid in the wash water sample is determined to be below a target threshold (e.g., 200 ppm), an operator or the controller 20 can control a pump to the peracetic acid supply to add additional peracetic acid to the recirculated water. Alternatively, if the amount of peracetic acid is too high, the operator or the controller 20 can add a neutralizing agent that neutralizes the peracetic acid, or can flush the system with water.

The systems and methods described herein provide a convenient and reliable system for real-time quantification and control of peroxyacids in a fluid stream. By using a direct measurement of the iodine complexes, the variability resulting from operator error and degradation can be eliminated or substantially reduced as compared to prior art methods. Additionally, if the reaction sample is measured using the iodine/triiodide isosbectic point, the reagent can be fed without any interference from overfeeding. This allows the system to measure a broad range of peracetic values with one set reagent feed rate.

It will be appreciated that the above-disclosed features and functions, or alternatives thereof, may be desirably combined into different systems or methods. Also, various alternatives, modifications, variations or improvements may be subsequently made by those skilled in the art, and are also intended to be encompassed by the following claims. As such, various changes may be made without departing from the spirit and scope of this disclosure as defined in the claims.

What is claimed is:

1. A method for determining an amount of peroxyacid in a fluid comprising:
(i) combining an iodide-containing reagent with the fluid, and allowing peroxyacid in the fluid to react with the iodide from the reagent;
(ii) then measuring an absorbance of the fluid at a wavelength that is in the range of from 459 nm to 469 nm; and
(iii) determining the amount of peroxyacid in the fluid based on the measured absorbance.

2. The method of claim 1, wherein the fluid includes at least 25 ppm of the peroxyacid.

3. The method of claim 1, wherein the fluid includes at least 100 ppm of the peroxyacid.

4. The method of claim 1, wherein the peroxyacid comprises peracetic acid.

5. The method of claim 1, wherein the fluid comprises water.

6. The method of claim 1, wherein the fluid comprises wash water from a sterilization system in a meat-packing plant.

7. The method of claim 1, wherein the iodide-containing reagent is added to the fluid so that an iodide concentration in the fluid is at least 1,000 ppm.

8. The method of claim 1, wherein the peroxyacid comprises performic acid.

9. The method of claim 1, wherein the absorbance of the fluid is measured at a wavelength that is in the range of from 462 nm to 466 nm.

10. The method of claim 1, wherein the absorbance of the fluid is measured at the isosbectic wavelength of iodine and triiodide.

11. The method of claim 1, further comprising (iv) measuring the absorbance of the fluid at the wavelength that is in the range of from 459 nm to 469 nm before the iodide-containing reagent is combined with the fluid.

12. The method of claim 11, wherein the step of determining the amount of peroxyacid comprises subtracting the measured absorbance in step (iv) from the measured absorbance in step (ii).

13. The method of claim 1, wherein the step of determining the amount of peroxyacid comprises comparing the measured absorbance in step (ii) with a standard calibration curve.

14. A system for analyzing the peroxyacid content in water comprising:
(i) a reagent vessel that contains an iodide-containing reagent;
(ii) a fluid conduit or fluid container configured to receive the water and the iodide-containing reagent, and allow peroxyacid in the water to react with the iodide from the reagent to provide a reaction fluid; and
(iii) a spectrophotometer that is configured to emit light at a wavelength that is in the range of from 461 nm to 467 nm, and measure an absorbance of the reaction fluid at the wavelength.

15. The system of claim 14, further comprising a controller that is configured to determine the amount of the peroxyacid in the water based on the measured absorbance of the reaction fluid.

16. The system of claim 14, further comprising a pump that pumps the iodide-containing reagent into the fluid conduit or fluid container.

17. The system of claim 16, wherein the controller is configured to control the pump.

18. The system of claim 14, further including a pH sensor that measures the pH of the reaction fluid.

19. The system of claim 14, further including a turbidity sensor that measures the turbidity of the reaction fluid.

20. The system of claim 14, wherein the spectrophotometer is configured to measure the absorbance of the reaction fluid at the isosbectic wavelength of iodine and triiodide.
